(19) United States
(12) Patent Application Publication
(10) Pub. No.: US 2020/0103140 A1
(43) Pub. Date: Apr. 2, 2020

(54) HUMIDIFIER WATER FILTER

(71) Applicant: Guardian Technologies LLC, Euclid, OH (US)

(72) Inventor: Jeffery Davis, Bedford, OH (US)

(21) Appl. No.: 16/585,960

(22) Filed: Sep. 27, 2019

Related U.S. Application Data
(60) Provisional application No. 62/737,326, filed on Sep. 27, 2018.

(51) Int. Cl. F24F 13/28; F24F 3/14

(52) U.S. Cl. CPC F24F 13/28; B01D 2201/305; B01D 2201/302; F24F 3/14

(57) ABSTRACT

Systems and methods for filtering fluid in a humidifier include According to an embodiment, a filter for a humidifier includes a housing having a hole allowing fluid to flow into the housing, ion resin within the housing and a channel vertically through the ion resin. The channel has a hollow center portion and an aperture allowing fluid to flow from the ion resin into the hollow center. A filter cap is secured to the housing. The filter cap has a hole and a one-way valve. The one-way valve restricts the flow of water into the filter through the hole. The housing is securable to a reservoir cap of a humidifier.

### RELATED APPLICATIONS

This non-provisional utility patent application claims priority to and the benefits of U.S. Provisional Patent Application Ser. No. 62/737,326, filed on Sep. 27, 2018, and entitled HUMIDIFIER WATER FILTER, which application is incorporated herein by reference in its entirety.

### BACKGROUND

The present disclosure generally relates to water filtration, and, more specifically, to water filters for a humidifier.

Humidifiers have long been used to increase humidity in otherwise dry environments. Dry air is known to cause or exacerbate many common ailments, including dry eyes, sore throat, dry nasal passages, bloody noses, colds and flu, chapped skin and lips, itchy, dry skin, asthma and allergies. While some buildings incorporate humidifiers into their heating, ventilation, and air conditioning systems, most consumers rely on far-less expensive portable humidifiers. These portable humidifiers generally generate moisture (i.e., humidify) in one of three ways: (1) warm mist humidifiers use a heating element to boil water into steam or vapor; (2) cool mist humidifiers blow air across a wick that is saturated with water to create vapor; and (3) ultrasonic humidifiers vibrate a metal or ceramic diaphragm to force water droplets into the air to create an aerosol.

Each of the above humidifier types generally uses common tap water supplied by a user as its water source, typically stored in a refillable reservoir of the humidifier. Common tap water typically contains mineral components such as magnesium (Mg²⁺), calcium (Ca²⁺), and other ionized molecules. When the water is vaporized or dispersed in to air, these minerals are left behind, and may form deposits that clog components of the humidifier, or cause components, such a heating element, to malfunction. These deposits are also difficult to remove. It is therefore desirable to filter such minerals from water before the water is vaporized or dispersed.

Current filtering techniques for humidifiers suffer from numerous problems. For example, filter cartridges exist that a user can drop into a reservoir of a humidifier. These cartridges will filter some water it comes into contact with, but will also allow significant amounts of unfiltered water to be vaporized or dispersed. Accordingly, such solutions might lessen deposits slightly but not significantly. One example where water is filtered more completely requires that the humidifier draw water from a connected water line, and a filter is placed in-line with the water source. Such humidifiers are expensive, the filters are not easily replaceable, and the humidifier must be installed at or near a water source.

### SUMMARY

There is thus a need in the art for an easily replaceable humidifier filter for a portable humidifier that prevents unfiltered water from being vaporized or dispersed into air.

According to an embodiment, a filter for a humidifier includes a housing having at least one hole allowing fluid to flow into the housing, ion resin disposed within the housing, a channel member disposed vertically through the ion resin, the channel member having a hollow center portion and at least one aperture through the channel thereupon allowing fluid to flow from the ion resin into the hollow center portion of the channel, and a filter cap secured to the housing. The filter cap has at least one hole therethrough, and a cap having a one-way valve, the one-way valve restricting the flow of water into the filter through the at least one hole. The housing is securable to a reservoir cap of a humidifier.

According to another embodiment, a humidifier includes a base having a humidifying element and a reservoir capable of holding fluid, the reservoir having a detachable reservoir cap covering an aperture in the reservoir, wherein the reservoir cap regulates the flow of fluid from reservoir to the base. The humidifier further includes a filter securable to the reservoir cap and extending at least partially into the reservoir when the cap is secured to the reservoir. The filter includes a housing having at least one hole allowing fluid to flow into the housing from the reservoir, a channel member disposed vertically within the housing, wherein a space between the housing and the channel member defines a chamber and ion resin disposed within the chamber. The channel member has a hollow interior portion and at least one aperture thereupon allowing fluid to flow from the chamber into the hollow interior portion of the channel member. A filter cap is disposed on top of the housing. The filter cap has a one-way valve secured thereto, the one-way valve is configured to allow gas to flow from the filter cap into the reservoir and to prevent fluid from flowing out of the reservoir through the filter cap.

According to a further embodiment, a method of filtering fluid in a humidifier includes securing a filter to a cap of a reservoir of a humidifier, such that filter extends into the reservoir, receiving fluid from the reservoir through at least one hole in a housing of the filter, filtering the fluid by allowing the fluid to pass through ion resin within the filter, disposing of the filtered fluid by allowing the filtered fluid to pass from the ion resin into a channel disposed vertically within the ion resin, and venting gas from the filter into the reservoir by allowing the gas to travel up through the channel and out of a one-way valve disposed above the channel The one-way valve is configured to prevent fluid flow into the valve from the reservoir.

### BRIEF DESCRIPTION OF DRAWINGS

FIG. 1 is an exemplary view of a humidifier utilizing an exemplary filter according to the present disclosure.

FIG. 2 is an exploded view of an exemplary filter according to the present disclosure.

FIG. 3 is a cross-sectional view of an exemplary filter according to the present disclosure showing water flow through the filter.

FIG. 4 is a cross-sectional view of an exemplary filter according to the present disclosure showing air flow through the filter.

### DETAILED DESCRIPTION

The present disclosure relates to filters for humidifiers. The filters are designed to be easily installable and removable for replacement in a portable humidifier, while also preventing non-filtered water from being vaporized or dispersed. Accordingly, the disclosed filters are lower in cost, easier to use and more effective than prior humidifier filter designs.

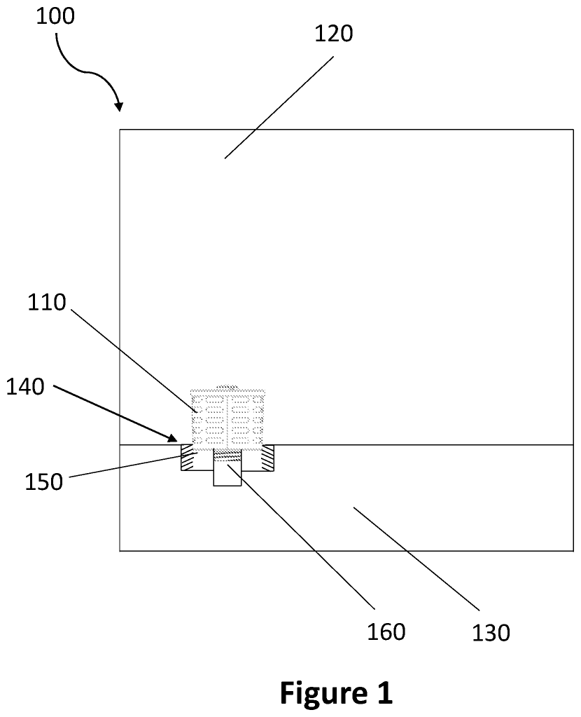

FIG. 1 depicts an exemplary humidifier 100 using an exemplary filter 110 according the present disclosure. The humidifier includes a reservoir 120 which is detachable from a base 130. Other configurations are contemplated, for example top-fill humidifiers wherein the reservoir 120 is not detachable from the base 130 and the reservoir 120 is filled through a hole in the top of the reservoir 120. The reservoir 120 is fillable with water through an aperture 140 when the reservoir is removed from the base and inverted. The aperture 140 is partially sealable with a cap 150. According to one embodiment, the aperture 140 includes a male threaded portion for securing thereupon a female threaded portion of the cap 150.

The cap 150 also includes a valve (not shown) for regulating the flow of water from the reservoir to the base 130. The water-regulating valve (not shown) may be, for example, a spring-loaded member that is biased to keep the valve closed when not actuated. The spring-loaded member may be actuated (and the valve opened) by a protruding member (not shown) in the based 130, such that no water is permitted to flow out from the reservoir 120 through the cap 150 unless the reservoir 120 is properly seated upon the base 130 and the protruding member actuates the spring-loaded member of the valve. In another exemplary embodiment, the water-regulating valve (not shown) may be a valve that is actuated by a float that changes position based on water level in the base 130. The base 130 includes a chamber (not shown) for holding water to be vaporized or dispersed, a humidifying mechanism (not shown), such as a heating element, a wick, or an ultrasonic vibrator, and a fan (not shown) for conveying vaporized and/or dispersed water into the atmosphere.

The cap includes a threaded aperture 160 that is configured to receive matching threads on filter 110 for detachably securing filter 110 to the cap 150. As explained in more detail below, the filter 110 uses an ion resin to remove minerals from water flowing from the reservoir 120 to the base 130. Such ion resin, however, has a limited lifetime and must be replaced after a certain period of use. Because the filter 110 is separate from all other components of the humidifier 100, including the cap 150, the cost of periodically replacing the filter 110 is minimal, as no other components need to be replaced with the filter 110.

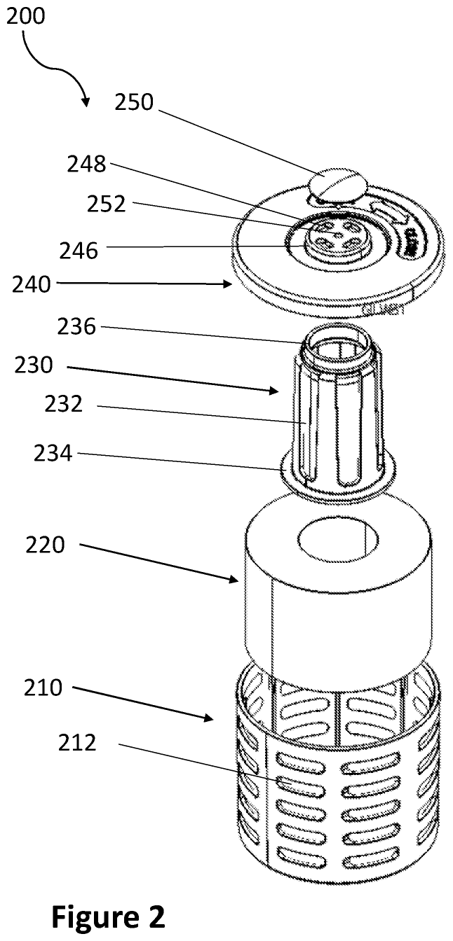

FIG. 2 illustrates an exploded view of an exemplary filter 200 according to the present disclosure. The filter 200 includes an outer housing 210, which, in the embodiment shown, has a generally cylindrical shape. Based on the shape of the filter 200, the housing 210 may take other shapes, for example a cube, prism or frustoconical shape. The outer housing 210 includes a plurality of holes 212. The holes 212 allow water to enter the filter 200 from a water reservoir (not shown). While the oval shape of the holes 212 and their columnar arrangement shown on the exemplary outer housing 210 may be preferred, one or ordinary skill in the art would appreciate that any number of holes and arrangement thereof is possible, with the understanding that number and arrangement of holes should allow sufficient water flow into the filter 200.

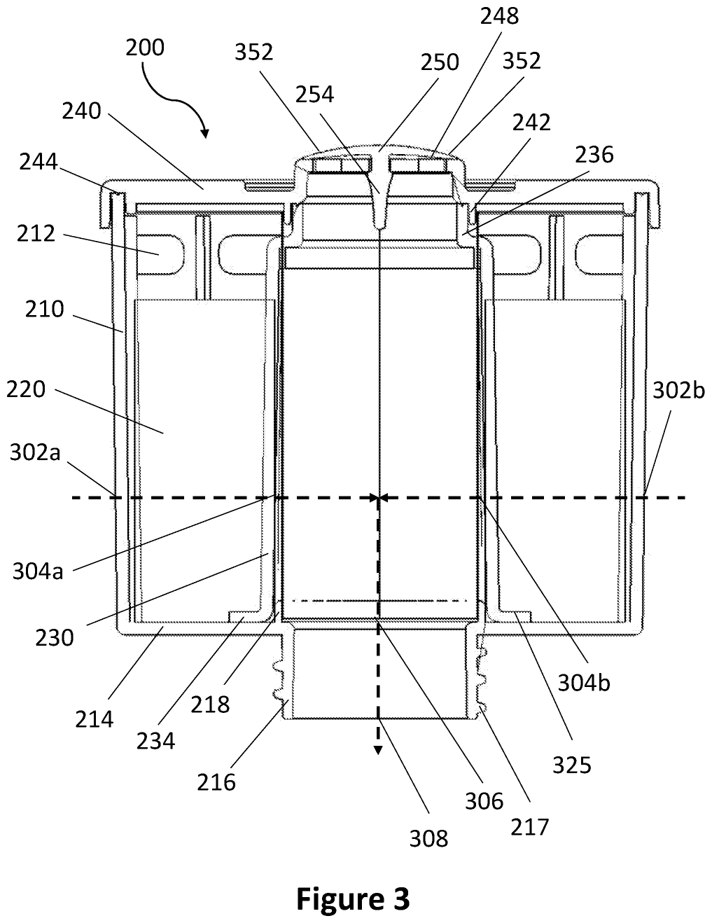

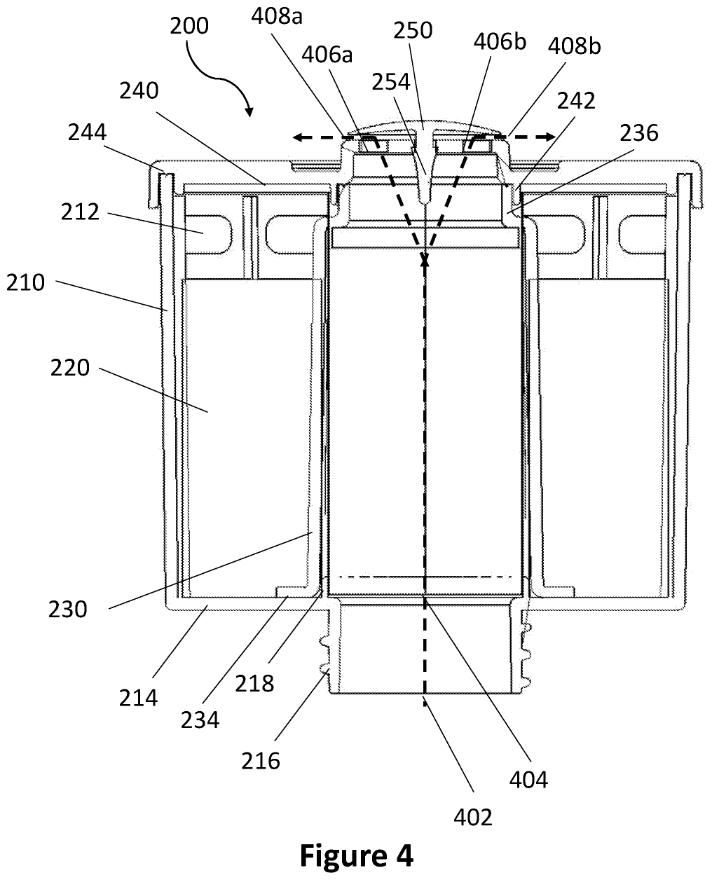

The outer housing 210 further includes a bottom portion 214 (FIG. 3), which has a connector 216 that includes an opening therethrough (these components are not visible in the view of FIG. 2 but can be seen in FIGS. 3 and 4) for connecting the filter 200 into a cap (not shown) of humidifier reservoir, as discussed above. In some embodiments, the connector 216 has an outer threaded portion 217 for connecting to a corresponding inner threaded portion of a reservoir cap (not shown). Other methods of connection may include, but are not limited to, having threads on the inside of the connector 216, using a compression fit between the connector 216 and a receiving member of the cap, having a snap fit connection, or the like. It is also contemplated that filter 200 may be more permanently fixed to the cap, such as through plastic welding, adhesive or chemical bonding, or by forming the cap (not shown) and filter housing 210 as integral components.

In some embodiments, the inside of the housing bottom portion 214 incudes a seat or retention member 218 for retaining the center channel 230 as described in more detail below. In some embodiments the retention member 218 is fully annular, creating a protruding ring on the inside of the bottom portion 214 (or another shape if the shape of the housing 210 and/or resin chamber 220 are not annular). In other embodiments, the retention member 218 may not be fully annular or may be broken into two or more sub-members, with gaps between. In some embodiments, retention member 218 is configured so that there is sufficient friction between the retention member 218 and center channel 230 to keep the center channel 230 in place.

The filter 200 further includes an ion resin chamber 220 that is formed between the outer housing 210 and center channel 230 and contains ion resin. The ion resin chamber 220 depicted is annular as discussed in more detail below. In embodiments where the filter 200 has a shape other than cylindrical, the ion resin chamber 220 can be any like shape as it will constitute the void between the outer housing 210 and center channel 230.

The ion resin chamber 220 holds ion resin that is designed to remove charged minerals from water that flows through the ion resin. In one embodiment, the ion resin is formed of plurality of microbeads, and thus holds no distinct, singular shape. In other exemplary embodiments the ion resin is formed from a matrix of polystyrene or acrylic material, and this holds a rigid or semi-rigid shape. Preferably, the ion resin is sufficiently dense such that air cannot flow through it. The ion resin is bound with functional groups having charged ions that will bind to minerals wished to be removed from water flowing through the ion resin. For example, a sulphonate (SO3−) or Hydroxide (OH−) functional group charged hydrogen ions (H+) is known remove minerals from water.

As explained above, the shape of the ion resin chamber 220 will depend on the shape of the surrounding outer housing 210 and center channel 230. The center channel 230 may be cylindrical in shape, or, as shown in the embodiments of FIGS. 2-4, frustoconical shaped, having a body with a larger diameter at the bottom than at the top, or various other shapes. As explained earlier, the center channel 230 may also have a non-circular cross-sectional shape in embodiments where the outer housing 210 and/or resin chamber 220 are likewise non-circular.

The center channel 230 has one or more apertures 232 that allow water to flow from the ion resin 220 into the center of the center channel 230 and eventually out of the bottom of the center channel 230. The flow of water through the filter 200 is described in more detail below in reference to FIG. 3.

The center channel 230 also includes a bottom member 234 that extends laterally out from the bottom of the center channel 230. Preferably, the bottom member 234 rests against the inside of the bottom portion 214 of the outer housing 210 such that when compressed, no water can flow between the bottom portion 214 of the outer housing 210 and the bottom member 234. In some embodiments compressive force on the bottom member 234 comes from the resin top cap 240, as described below. It is also contemplated that the bottom member 234 may be bonded to the bottom portion 214 of the outer housing 210 by welding, adhesive or chemical bonding. Note that the exploded view of FIG. 2 should not be interpreted as showing the parts assembled in the shown order.

The center channel 230 further includes a top connection member 236, which in this exemplary embodiment is an annular projection, for connecting the center channel 230 to a top cap 240. In some embodiments, the diameter of the top connection member 236 is smaller than the diameter of the smallest diameter of the main body of the center channel 230. In some embodiments, the top connection member 236 is secured to retention member 242 of the top cap 240 with a friction fit (this component is not visible in the view of FIG. 2 but can be seen in FIGS. 3 and 4). Other types of connections may be used, such as, for example, a snap-fit connection, a threaded connection, an adhesive based connection or the like. In some embodiments, the connection is water-tight, i.e. it prevents or eliminates water from flowing past the connection.

The top cap 240 as illustrated in the embodiment of filter 200 is round and configured to fit the exemplary round filter 200, though one of ordinary skill in the art would appreciate that its shape may be any suitable shape configured to connect to the housing 210 of the filter 200, and may correspond to a variety of shapes of the housings. In exemplary embodiments, as explained above, the top cap 240 includes a retention member 242 for securing to top connection member 236 of the center channel 230. In exemplary embodiments, the top cap 240 includes a channel or groove 244 around the perimeter of the top cap 240 designed to accept the top edge of the housing 210, such that top cap 240 may be fitted to the outer housing 210 (this component is not visible in the view of FIG. 2 but can be seen in FIGS. 3 and 4). In some embodiments, the groove 244 and the top edge of the outer housing 210 are connected using a compression fit. In some embodiments, the groove 244 and the top edge of the outer housing 210 are threaded such that the top cap 240 can be screwed onto the housing 210. In other embodiments, the top cap 240 is bonded to the outer housing 210 using adhesive, chemical bonding, welding or the like. In some embodiments, the top cap 240 is connected to housing 210 using a snap fit connection, or the like.

The top cap 240 includes a center portion 246 that regulates the flow of air out of the filter 200 through use of a one-way valve 250. The center portion 246 as illustrated in the embodiment is raised from the to cap 240, but it is contemplated that the center portion 246 may be flush with the top surface of the top cap 240, or recessed in other embodiments. The center portion 246 includes one or more holes, such as hole 248, which allow air to pass out of the filter 200 through the valve 250. As with the holes 212 in the housing 210, one or ordinary skill in the art would appreciate that any number of holes and arrangement thereof is possible, with the understanding that number and arrangement of holes should allow sufficient air to flow out the filter 200 via the valve 250, while preventing water from entering the filter 200 via the valve 250.

The valve 250 is a one-way valve that allows air to exit the filter from beneath the valve, via, for example, hole 248, while preventing water from entering the filter 200. In an exemplary embodiment, the valve 250 is affixed to the cap 240 through an aperture 252. In the exemplary embodiment, the valve 250 has a wedge-shaped stem 254, that allows the valve 250 to be easily inserted into the valve-aperture 252, while preventing removal and creating a sufficiently tight fit against the center portion 246 of the top cap 240 as to create a seal against water entering the filter 200 through the hole(s) 248 in the top cap 240. Valve 250 includes a resilient flexible portion 352 that flexes to allow air to escape from the center of the filter 200 and reseats to prevent water from flowing into filter 200.

Components of the filter 200, such as the housing 210, center channel 230 and top cap 240 may be made from any suitable material, for example a rigid polymer, and may be formed unitarily or as joined components using techniques such as injection molding, 3D printing, and the like. The valve 250 may be made of any suitable elastomeric material, such as natural or synthetic rubber, or any flexible polymer sufficient to provide a seal against water entering the filter 200 through the valve 250.

It should be appreciated that a major benefit of the disclosed filter 200 is that it prevents unfiltered water from passing through the filter 200 into the base 130, thus preventing vaporization or dispersing of unfiltered water. FIG. 3 illustrates an exemplary flow of water through the filter 200. Specifically, the flow of water is illustrated by dashed lines. For example, water enters the filter at points 302a and 302b through a hole in housing 210, similar to the exemplary hole 212 shown. The water then passes through ion resin in the ion resin chamber 220, where it is filtered to remove unwanted mineral components. The filtered water then exits the ion resin chamber 220, at points 304a and 304b for example, and enters the center channel 230 through an aperture such as aperture 232 shown in FIG. 2. Gravity then pulls the filtered water downward through the center channel 230 such that it exits through the bottom of the center channel 230 into the connector 216 at the bottom of the housing 210, for example at point 306. Finally, at point 308, for example, the filtered water exits the connector 216 at the bottom of the housing 210 to flow into the humidifier reservoir, wherein the filtered water will be discharged for humidifying the air.

It should be noted that filter 200 is designed to prevent the flow of water from outside the filter to the humidifier reservoir in any way that does not pass through the ion resin in the ion resin chamber 220. For example, the valve 250 prevents water from entering the center channel 230 from the top of the filter 200. The juncture between the bottom portion 214 of the outer housing 210 and the bottom member 234 (whether bonded or compressed) prevents water from flowing under the resin chamber 220 and between the bottom portion 214 of the housing 210 and the bottom member 234. Accordingly, the filter deign prevents unfiltered water from exiting the filter 200 to the humidifier reservoir.

In order for proper exchange of water between the reservoir 120 and humidifier base 130 to occur, there must also be a way for air to pass into the reservoir 120 as water flows out of the reservoir 120. FIG. 4 illustrates an exemplary flow of air through the filter 200. Specifically, the flow of air is illustrated by dashed lines. As water is pulled down into the humidifier base 130, air flows up into the filter 200 from the humidifier base 130 into the connector 216 at the bottom of the outer housing 210, for example at point 402. Due the lower density of air compared to surrounding water, the air flows up into the center channel 230, for example at point 404. The air then flows all the way up through the center channel 230 until it reaches a hole, for example hole 248, in the top cap 240. It should be noted that the resin in the ion resin chamber 220 is generally too dense to allow air to pass through it and thus it is unlikely that any air will escape through the ion resin chamber 220 via apertures 232 in the center channel 230. At points 406a and 406b, for example, the air exists the top cap 240 beneath the valve 250, which allows flow of air outward, but does not allow flow of water inward. Finally, the air exists the filter 200 into the reservoir from the valve 250 at, for example, points 408a and 408b.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Accordingly, departures may be made from such details without departing from the spirit or scope of the applicant's general inventive concept.

What is claimed is:

1. A filter for a humidifier, comprising:
a housing having at least one hole allowing fluid to flow into the housing;
ion resin disposed within the housing;
a channel member disposed vertically through the ion resin;
the channel member having a hollow center portion and at least one aperture through the channel thereupon allowing fluid to flow from the ion resin into the hollow center portion of the channel; and
a filter cap secured to the housing,
the filter cap having at least one hole therethrough;
the filter cap having a one-way valve;
the one-way valve restricting the flow of water into the filter through the at least one hole,
wherein the housing is securable to a reservoir cap of a humidifier.

2. The filter of claim 1, wherein the housing is annular.

3. The filter of claim 1, wherein the housing includes a threaded member for securing the filter to the reservoir cap.

4. The filter of claim 1, wherein filter cap is configurable to regulate gas flow out of the filter.

5. The filter of claim 1, wherein the filter cap is secured to the housing by a compression fit.

6. The filter of claim 1, wherein the filter cap includes a threaded portion for securing the filter cap to the housing.

7. The filter of claim 1, wherein the filter cap is integrally formed with the housing.

8. A humidifier comprising:
a base having a humidifying element;
a reservoir capable of holding fluid, the reservoir having a detachable reservoir cap covering an aperture in the reservoir, wherein the reservoir cap regulates the flow of fluid from reservoir to the base;
a filter securable to the reservoir cap;
the filter extending at least partially into the reservoir when the cap is secured to the reservoir,
the filter having:
a housing having at least one hole allowing fluid to flow into the housing from the reservoir,
a channel member disposed vertically within the housing, wherein a space between the housing and the channel member defines a chamber;
ion resin disposed within the chamber,
the channel member having a hollow interior portion;
the channel member having at least one aperture thereupon allowing fluid to flow from the chamber into the hollow interior portion of the channel member, and
a filter cap disposed on top of the housing;
the filter cap having a one-way valve secured thereto;
the one-way valve configured to allow gas to flow from the filter cap into the reservoir and to prevent fluid from flowing out of the reservoir through the filter cap.

9. The humidifier of claim 8, wherein the housing and chamber are annular.

10. The humidifier of claim 8, wherein the housing includes a threaded member for securing the filter to the reservoir cap.

11. The humidifier of claim 8, wherein the filter cap is secured to the housing by a compression fit.

12. The humidifier of claim 8, wherein the filter cap includes a threaded portion for securing the filter cap to the housing.

13. The humidifier of claim 8, wherein the filter cap and the housing are a unitary member.

14. The humidifier of claim 8, wherein the humidifying element is configured to vaporize from the base.

15. The humidifier of claim 8, wherein the humidifying element is configured to disperse fluid from the base into surrounding atmosphere.

16. A method of filtering fluid in a humidifier, the method comprising:
securing a filter to a cap of a reservoir of a humidifier, such that filter extends into the reservoir,
receiving fluid from the reservoir through at least one hole in a housing of the filter;
filtering the fluid by allowing the fluid to pass through ion resin within the filter;
disposing of the filtered fluid by allowing the filtered fluid to pass from the ion resin into a channel disposed vertically within the ion resin; and
venting gas from the filter into the reservoir by allowing the gas to travel up through the channel and out of a one-way valve disposed above the channel, the one-way valve being configured to prevent fluid flow into the valve from the reservoir.

17. The method of claim 16 wherein the securing step includes screwing the filter into the reservoir cap.

18. The method of claim 16, wherein the securing step includes screwing the filter into the reservoir cap.

19. The method of claim 16, further comprising removing the filter from the reservoir cap, and securing a new filter to the reservoir cap.
